(19) United States
(12) Patent Application Publication
(10) Pub. No.: US 2005/0224701 A1
(43) Pub. Date: Oct. 13, 2005

(54) Light-based data communication in a data-processing system

(75) Inventor: Paul R. Austin, Webster, NY (US)

Correspondence Address: Ortiz & Lopez, PLLC, P.O. Box 4484, Albuquerque, NM, 87196-4484, US

(73) Assignee: Xerox Corporation

(21) Appl. No.: 10/812,478

(22) Filed: Mar. 30, 2004

(51) Int. Cl. G06M 7/00

(52) U.S. Cl. 250/221

(57) ABSTRACT

A light-based data communications method and system are disclosed herein. At least one light source and at least one light sensor can be associated with at least one component of a data-processing system. At least one other light source and at least one other light sensor can be associated with at least one other component of the data-processing system. Data can then be communicated data between the components of the data-processing system by transmitting light from a light source thereof to a respective light sensor and vice versa. A light path can be established between such components of the data-processing system in order to communicate data by light among the various light sources and light sensors.

### TECHNICAL FIELD

Embodiments are generally related to data-processing systems. Embodiments are also related to light-based data communication techniques, systems, and devices thereof. Embodiments are additionally related to light sensors and light sources for transmitting, detecting and receiving light-based data.

### BACKGROUND OF THE INVENTION

Current data-processing systems rely upon a variety of control components linked by cable and wired communication devices. Cables, for example, can provide for the transmission of data among various electronic components of a data-processing system. Such cables are often custom-designed, expensive, increase system service time and are a frequent source of system reliability problems due to incorrect installation, loose connections, and wear. Examples of cables used in current data-processing systems include IDE and small computer system interface (SCSI) cables, which are employed by many personal computers to connect data-processing system components such as hard drives and CD or DVD devices to the main processor board.

A small computer system interface (SCSI), for example, is a well known and widely used type of interface in the computer field. A SCSI is generally used to couple a computer system to a device or to couple computer devices together. Communications are provided between a computer system and a device or provided between devices through the SCSI interfaces and by using a SCSI protocol. A SCSI, however, is limited to the distance within which signals may be able to traverse or be transmitted. Typically, signal degradation begins to occur for a SCSI within a twenty (20) meter range.

A need thus exists for decreasing the usage of cables and wires such as SCSI or IDE cables in data-processing systems, such as personal computers, computer workstations, computer servers, or any other computer-based electronic device, such as, for example, consumer appliances.

### BRIEF SUMMARY

It is, therefore, a feature of the present invention to provide for light-based data communication among various components of a data-processing system.

It is another feature of the present invention to provide for light sources and light sensors, which can transmit and receive light-based data.

Aspects of the present invention relate to methods and systems for data communications in a data-processing system by light transfer. In general, at least one light source and at least one light sensor can be associated with at least one component of a data-processing system. At least one other light source and at least one other light sensor can be associated with at least one other component of the data-processing system. Data can then be communicated data between the components of the data-processing system by transmitting light from a light source thereof to a respective light sensor and vice versa.

A light path can be established between such components of the data-processing system in order to communicate data by light among the various light sources and light sensors. The light source(s) can be provided by devices, such as an LED or a laser light source such as a Vertical Cavity Surface Emitting Laser (VCSEL). One or more mirrors can be employed to guide light emitted from a light source to an opposing light sensor. Thus, a light path can be established between the components of the data-processing system in order to communicate data by light among the various light sources and light sensors.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a pictorial representation of a computer system in which a preferred embodiment of the present invention can be implemented;

FIG. 2 illustrates a block diagram of a representative hardware environment of the processing unit of the computer system depicted in FIG. 1;

FIG. 3 illustrates a block diagram of a light-based data communications system, which can be implemented in accordance with a preferred embodiment of the present invention;

FIG. 4 illustrates a block diagram of a light-based data communications system, which can be implemented in accordance with an alternative embodiment of the present invention.

### DETAILED DESCRIPTION OF THE INVENTION

The particular values and configurations discussed in these non-limiting examples can be varied and are cited merely to illustrate embodiments of the present invention and are not intended to limit the scope of the invention.

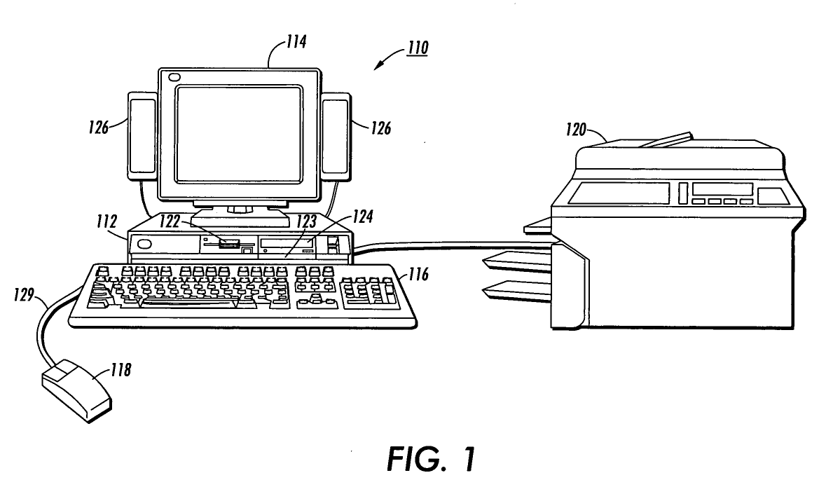

With reference now to the figures and in particular with reference to FIG. 1, there is depicted an embodiment of a computer system that can be utilized to implement a preferred embodiment. Data-processing system 110 generally includes processing unit 112, display device 114, keyboard 116, pointing device 118, printer 120, and speakers 126. Processing unit 112 can receive input data from input devices such as keyboard 116, pointing device 118, and local area network interfaces (not illustrated) and presents output data to a user via display device 114, printer 120, and speakers 126.

Keyboard 116 is that part of data-processing system 110 that resembles a typewriter keyboard and that enables a user to control particular aspects of the computer. Because information flows in one direction, from keyboard 114 to processing unit 112, keyboard 116 functions as an input-only device. Functionally, keyboard 116 represents half of a complete input/output device, the output half being video display terminal 114. Keyboard 116 includes a standard set of printable characters presented in a “QWERTY” pattern typical of most typewriters. In addition, keyboard 116 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video-display terminal 114.

Video-display terminal 114 can be implemented as the visual output of data-processing system 110. As indicated herein, video-display terminal 114 can be a cathode-ray tube (CRT) based video display well-known in the art of computer hardware. But, with a portable or notebook-based computer, video-display terminal 114 can be replaced with a liquid crystal display (LCD) based or gas, plasma-based, flat-panel display.

Pointing device 118 is preferably utilized in conjunction with a graphical user-interface (GUI) in which hardware components and software objects are controlled through the selection and the manipulation of associated, graphical objects displayed within display device 114. Although data-processing system 110 is illustrated with a mouse for pointing device 118, other graphical-pointing devices such as a graphic tablet, joystick, track ball, touch pad, or track pad could also be utilized. Pointing device 118 features a casing with a flat bottom that can be gripped by a human hand. Pointing device 118 can include buttons on the top, a multidirectional-detection device such as a ball on the bottom, and cable 129 that connects pointing device 118 to processing unit 112.

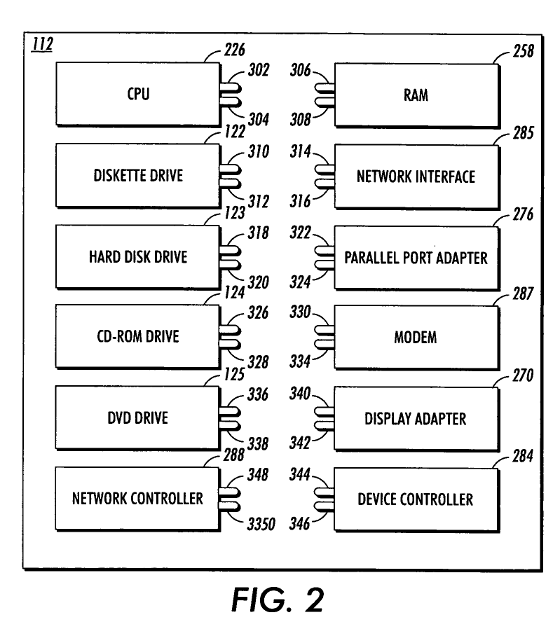

To support storage and retrieval of data, processing unit 112 further includes diskette drive 122, hard-disk drive 123, and CD-ROM drive 124, which are interconnected with other components of processing unit 112, and which are further described below under the description for FIG. 2. Data-processing system 110 can be implemented utilizing any suitable computer. But, a preferred embodiment of the present invention can apply to any hardware configuration that allows the display of windows, regardless of whether the computer system is a complicated, multi-user computing apparatus, a single-user workstation, or a network appliance that does not have non-volatile storage of its own.

Referring to FIG. 2, there is depicted a block diagram of the principal components of processing unit 112. CPU 226 can communicate with RAM (Random Access Memory) 258, diskette drive 122, hard-disk drive 123, CD-ROM drive 124, DVD Drive 125, device controller 284, parallel-port adapter 276, network interface 285, display adapter 270, modem 287, and network controller 350. Although the various components of FIG. 2 are drawn as single entities, each may consist of a plurality of entities and may exist at multiple levels.

Processing unit 112 includes central processing unit (CPU) 226, which executes instructions. CPU 226 includes the portion of data-processing system 110 that controls the operation of the entire computer system, including executing the arithmetical and logical functions contained in a particular computer program. Although not depicted in FIG. 2, CPU 226 typically includes a control unit that organizes data and program storage in a computer memory and transfers the data and other information between the various parts of the computer system. CPU 226 generally includes an arithmetic unit that executes the arithmetical and logical operations, such as addition, comparison, and multiplication. CPU 226 accesses data and instructions from and stores data to volatile RAM 258.

CPU 226 can be implemented, for example, as any one of a number of processor chips, or any other type of processor, which are available from a variety of vendors. Although data-processing system 110 is shown to contain only a single CPU and a single system bus, the present invention applies equally to computer systems that have multiple CPUs and to computer systems that have multiple buses that each performs different functions in different ways.

RAM 258 comprises a number of individual, volatile-memory modules that store segments of operating system and application software while power is supplied to data-processing system 110. The software segments are partitioned into one or more virtual-memory pages that each contains a uniform number of virtual-memory addresses. When the execution of software requires more pages of virtual memory than can be stored within RAM 258, pages that are not currently needed are swapped with the required pages, which are stored within non-volatile storage devices 122 or 123. RAM 258 is a type of memory designed such that the location of data stored in it is independent of the content. Also, any location in RAM 258 can be accessed directly without needing to start from the beginning.

Hard-disk drive 123 and diskette drive 122 are electromechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from data-processing system 110.

A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semi permanent basis. Because the magnetic coating of the disk must be protected from damage and contamination, a floppy disk (e.g., 5.25 inch) or micro-floppy disk (e.g., 3.5 inch) is encased in a protective plastic jacket. But, any size of disk could be used. A hard disk, which is very finely machined, is typically enclosed in a rigid case and can be exposed only in a dust free environment. Keyboard/pointing-device controller 284 interfaces processing unit 112 with keyboard 116 and graphical-pointing device 118. In an alternative embodiment, keyboard 116 and graphical-pointing device 118 have separate controllers. Display adapter 270 can translates graphics data from CPU 226 into video signals utilized to drive display device 114.

Processing unit 112 includes network adapter 285, modem 287, and parallel-port adapter 276, which facilitate communication between data-processing system 110 and peripheral devices or other computer systems. Parallel-port adapter 276 transmits printer-control signals to printer 120 through a parallel port. Network adapter 285 connects data-processing system 110 to an un-illustrated local area network (LAN). A LAN provides a user of data-processing system 110 with a means of electronically communicating information, including software, with a remote computer or a network logical-storage device.

A LAN can support distributed processing, which enables data-processing system 110 to share a task with other computer systems linked to the LAN, which can also be implemented in the context of a wireless local area network (WLAN). Modem 287 supports communication between data-processing system 110 and another computer system over a standard telephone line. Furthermore, through modem 287, data-processing system 110 depicted in FIG. 1 can access other sources such as a server, an electronic bulletin board, and the Internet or the well-known World Wide Web.

Each component of processing unit 112 can be associated and/or integrated with a respective light source and/or light sensor. CPU 226 can be associated with light source 302 and light sensor 304, while RAM 258 can be associated with light source 306 and light sensor 308. Similarly, diskette drive 122 can be associated with light source 310 and light sensor 312, while network interface 285 can be associated with light source 314 and light sensor 316. Hard disk drive 123 can be associated with light source 318 and light sensor 320, while parallel port adapter 276 can be associated light source 322 and light sensor 324.

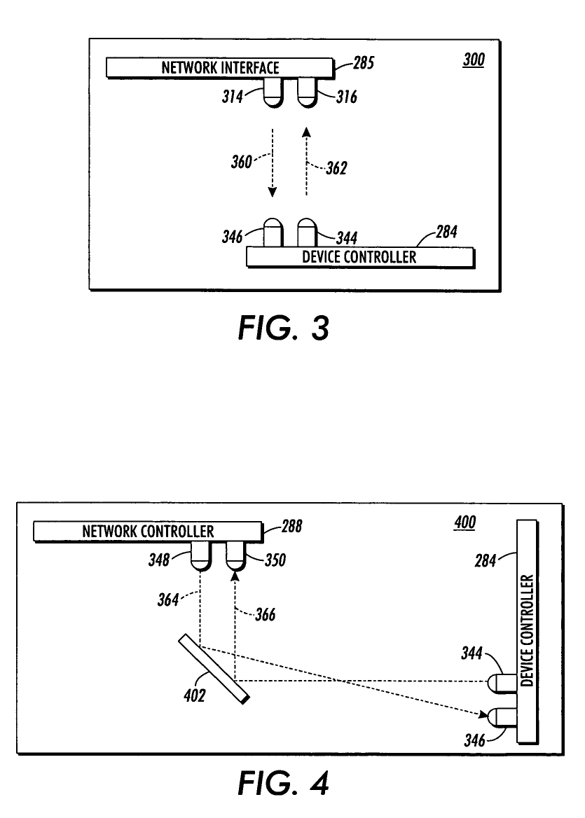

CD-ROM drive 124 is generally associated with light source 326 and light sensor 328, while modem 387 can be associated with light source 33 and light sensor 334. DVD drive 125 is generally associated with light source 336 and light sensor 338. Similarly, display adapter 270 is associated with light source 340 and light sensor 342. Likewise, network controller 288 is associated with light source 348 and light sensor 350. Finally, device controller 284 is associated with light source 344 and light sensor 346. In general, processing unit 112 and the various components thereof can operate according to variations of light-based data communications, which are depicted and described in further detail herein with respect to FIGS. 3-4.

The configuration depicted in FIG. 1 is but one possible implementation of the components depicted in FIG. 2. Portable computers, laptop computers, and network computers or Internet appliances are other possible configurations. The hardware depicted in FIG. 2 may vary for specific applications. For example, other peripheral devices such as optical-disk media, audio adapters, or chip-programming devices, such as PAL or EPROM programming devices well-known in the art of computer hardware, may be utilized in addition to or in place of the hardware already depicted.

FIG. 3 illustrates a block diagram of a light-based data communications system 300, which can be implemented in accordance with a preferred embodiment of the present invention. System 300 illustrates data-processing system components, which were also depicted in FIG. 2. Thus, in FIGS. 1-4, similar or identical parts or components are generally indicated by identical reference numerals. Thus, in the configuration of system 300, network interface 285 can be located opposite device controller 284. Network interface 285 is associated with a light source 314 and a light sensor 316, while device controller 284 is associated with a light sensor 346 and a light source 344. Light can be emitted by light source 314 and detected by light sensor 346. Similarly, light emitted from light source 344 can be detected by light sensor 316. A direct light path can thus be established between light source 314 and light sensor 346. Similarly, a direct light path can also be established between light source 344 and light sensor 316. In the configuration of system 300, the light sources and light sensors are directly aligned, but can be separated by a convenient distance of less than inch to several feet, depending upon design considerations. In FIG. 3, arrow 360 represents a direct light path between light source 314 and light sensor 346, while arrow 362 represents a direct light path between light source 344 and light sensor 316.

FIG. 4 illustrates a block diagram of a light-based data communications system 400, which can be implemented in accordance with an alternative embodiment of the present invention. In the configuration of system 400, network controller 288 is located generally perpendicular to device controller 284. Network controller 288 is associated with light source 348 and light sensor 350, while device controller 284 is associated with light sensor 346 and light source 344. Light can be emitted by light source 348 and detected by light sensor 346. Similarly, light emitted from light source 344 can be detected by light sensor 350. In system 400, however, a mirror 402 can be provided to assist in guiding light from light source 348 to light sensor 346 and from light source 344 to light sensor 350. Mirror 402 permits a more convenient location of communication sub-assemblies. In FIG. 4, arrow 364 represents a light path between light source 348 and light sensor 346, while arrow 366 represents a light path between light source 344 and light sensor 350.

Light sources 348 and 346 can be implemented as LED's, which each provide an appropriate light beam width that does not require the precise alignment of associate sensors and mirrors. The high bandwidth capabilities of relatively inexpensive LEDs can permit serialization techniques for minimizing the number of devices required. Source and sensors of several different wavelengths can be utilized to permit point-to-point independent and non-interfering communications utilizing the same physical space. Additionally, standard IEEE 802.3 communications protocols and similar contention management protocols can be utilized to permit bus style interconnections utilizing a source and a sensor on each connected module and a common light path visible to each connected module or component (e.g., RAM, CPU, etc.) of a data-processing system. For example, a mirror can be located at the end of the light path in order to reflect the signal back to other components of the data-process system.

Light sources 348 and 346 can also be implemented as light sources which generate laser light beams. An example of such a laser light source is a Vertical Cavity Surface Emitting Laser (VCSEL). A VCSEL is a type of edge emitting laser where light is emitted from the edge of a monolithic structure of semiconductor layers. A laser structure is a “VCSEL” where the light is emitted from the surface of the monolithic structure of semiconductor layers. Vertical cavity surface emitting lasers are very desirable light sources for high speed laser printing, optical fiber communications, optical sampling and other applications. VCSELs have several advantages over edge emitting lasers including an emitted beam with a small angular divergence, a circular, anastigmatic beam and ease of fabrication into one or two dimensional arrays.

Vertical cavity surface emitting lasers generally include a planar multi-layered semiconductor structure having one or more active semiconductor layers bounded at opposite semiconductor layers that act as mirrors. The semiconductor layers on one side of the active layer in the structure are doped with impurities so as to have an excess of mobile electrons. These layers with excess electrons are said to be n-type, i.e. negative. The semiconductor layers on the other side of the active layer in the structure are doped with impurities so as to have a deficiency of mobile electrons, therefore creating an excess of positively charged carriers called holes. These layers with excess holes are said to be p-type, i.e. positive.

An electrical potential can be applied through electrodes between the p-side and the n-side of the layered structure, thereby driving either holes or electrons or both in a direction perpendicular to the planar layers across the p-n junction so as to “inject” them into the active layers, where electrons recombine with holes to produce light. Optical feedback provided by the opposite semiconductor layers allows resonance of some of the emitted light to produce coherent “lasing” through either the top surface or the bottom surface of the semiconductor laser structure. Thus, for example, light sources 302, 306, 310, 314, 318, 322, 326, 330, 336, 340, 348 and 344 depicted in FIG. 2 can each be implemented as a VCSEL or an LED or another type of laser source or light source, depending upon design considerations.

An example of a VCSEL that can be adapted for use with one embodiment is disclosed in U.S. Pat. No. 6,304,588, “Method and structure for eliminating polarization instability in laterally-oxidized VCSELs,” which is assigned to the Xerox Corporation and issued to Chua, et al on Oct. 16, 2001. Another example of a VCSEL that can be adapted for use with another embodiment is disclosed in U.S. Pat. No. 6,552,328, “Microsensor including a VCSEL and method for electromechanical coupling of microsensors,” which is assigned to the Xerox Corporation and issued to Berlin, et al. on Apr. 22, 2003. A further example of a VCSEL that can be adapted for use with an alternative embodiment is disclosed in U.S. Pat. No. 6,515,308, “Nitride-based VCSEL or light emitting diode with p-n tunnel junction current injection,” which is assigned to the Xerox Corporation and issued to Kneissl, et al. on Feb. 4, 2003. U.S. Pat. Nos. 6,304,588, 6,552,328, and 6,515,308 are incorporated herein by reference.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
associating at least one light source and at least one light sensor with at least one component of a data-processing system;
associating at least one other light source and at least one other light sensor with at least one other component of said data-processing system; and
communicating data between said at least one component and said at least one other component of said data-processing system by transmitting light from said at least one light source to said at least one other light sensor or from said at least one other light source to said at least one sensor.

2. The method of claim 1 further comprising:
establishing at least one light path patch between said at least one component and said at least one other component of said data-processing system in order to communicate data by light among said at least one light source, said at least one sensor, said at least one other light source and said at least one other sensor.

3. The method of claim 1 further comprising:
configuring said at least one light source to comprise an LED; and
configuring said at least one other light source to comprise an LED.

4. The method of claim 1 further comprising
configuring said at least one light source to comprise a VCSEL; and
configuring said at least one other light source to comprise a VCSEL.

5. The method of claim 1 further comprising:
providing at least one mirror to guide light emitted from said at least one light source to said at least one other light sensor or light emitted from said at least one other light source to said at least one light sensor.

6. The method of claim 1 further comprising:
establishing at least one light path patch between said at least one component and said at least one other component of said data-processing system in order to communicate data by light among said at least one light source, said at least one sensor, said at least one other light source and said at least one other sensor; and
locating at least one mirror at an end of said at least one light path in order to guide light emitted from said at least one light source to said at least one other light sensor or light emitted from said at least one other light source to said at least one light sensor.

7. The method of claim 1 further comprising:
aligning said at least one component directly opposite said at least one other component in order to form at least one direct light path between said at least one light source and said at least one other sensor and said at least one other light source and said at least one light sensor.

8. The method of claim 1 further comprising:
aligning said at least one component perpendicular to said at least one other component in order to form a perpendicular light path between said at least one light source and said at least one other sensor and said at least one other light source and said at least one light sensor, wherein said perpendicular light path is guided by at least one mirror.

9. The method of claim 8 wherein said at least one mirror is located at 45 degree angle to said at least component and said at least one other component of said data-processing system.

10. The method of claim 1 wherein said light transmitted from said at least one light source to said at least one other light sensor and from said at least one other light source to said at least one sensor comprises IR light.

11. A system, comprising:
at least one light source and at least one light sensor associated with at least one component of a data-processing system;
at least one other light source and at least one other light sensor associated with at least one other component of said data-processing system; and
wherein data is communicated between said at least one component and said at least one other component of said data-processing system by transmitting light from said at least one light source to said at least one other light sensor or from said at least one other light source to said at least one sensor.

12. The system of claim 11 further comprising:
at least one light path patch established between said at least one component and said at least one other component of said data-processing system in order to communicate data by light among said at least one light source, said at least one sensor, said at least one other light source and said at least one other sensor.

13. The system of claim 11 wherein said at least one light source and said at least one other light source each comprise an LED.

14. The system of claim 11 wherein said at least one light source and said at least one other light source each comprise a VCSEL.

15. The system of claim 1 further comprising:
at least one mirror for guiding light emitted from said at least one light source to said at least one other light sensor or light emitted from said at least one other light source to said at least one light sensor.

16. A system, comprising:
at least one light source and at least one light sensor associated with at least one component of a data-processing system;
at least one other light source and at least one other light sensor associated with at least one other component of said data-processing system, wherein data is communicated between said at least one component and said at least one other component of said data-processing system by transmitting light from said at least one light source to said at least one other light sensor or from said at least one other light source to said at least one sensor;
at least one light path established between said at least one component and said at least one other component of said data-processing system in order to communicate data by light among said at least one light source, said at least one sensor, said at least one other light source and said at least one other sensor; and
locating at least one mirror at an end of said at least one light path in order to guide light emitted from said at least one light source to said at least one other light sensor and light emitted from said at least one other light source to said at least one light sensor.

17. The system of claim 16 further comprising:
at least one component located directly opposite said at least one other component in order to form a direct light path between said at least one light source and said at least one other sensor and said at least one other light source and said at least one light sensor.

18. The system of claim 16 further comprising:
at least one component located perpendicular to said at least one other component in order to form a perpendicular light path between said at least one light source and said at least one other sensor and said at least one other light source and said at least one light sensor, wherein said perpendicular light path is guided by said at least one mirror.

19. The system of claim 16 wherein said at least one light source and said at least one other light source each comprise an LED.

20. The system of claim 16 wherein said at least one light source and said at least one other light source each comprise a VCSEL.
